(19) United States
(12) Patent Application Publication
(10) Pub. No.: US 2007/0020511 A1
(43) Pub. Date: Jan. 25, 2007

(54) Cover for electric accumulator with free electrolyte and relative accumulator

(76) Inventor: Franco Stocchiero, Montoso Vicentino (VI) (IT)

Correspondence Address: BIRCH STEWART KOLASCH & BIRCH, PO BOX 747, FALLS CHURCH, VA, 22040-0747, US

(21) Appl. No.: 10/565,188

(22) PCT Filed: Jul. 22, 2004
(86) PCT No.: PCT/IT04/00400

§ 371 Date: Jul. 6, 2006

(30) Foreign Application Priority Data
Jul. 24, 2003 (IT) VI2003A000146

(51) Int. Cl. H01M 2/12; H01M 2/04

(52) U.S. Cl. 429/88; 429/175

(57) ABSTRACT

The invention concerns a cover (2, 200, 201, 203, 204) for an electric accumulator (1, 100, 101, 102, 103, 104) and an accumulator (1, 100, 101, 102, 103, 104). The cover has a valve device (9) having an inlet (10) that communicates with the cells (5) of the accumulator and en outlet communicating (11) with the external environment (A), the valve device being adapted to prevent the leaking of electrolyte (E) from the cells (5) and to allow the disposal to the outside of the gases that develop inside the accumulator (1, 100, 101, 102, 103, 104) when the pressure in the cells (5) exceeds a predetermined value.

The invention concerns a cover for an electric accumulator particularly adapted to be used in lead accumulators of the type with free electrolyte and the relative electric accumulator.

As known the casing of a lead electric accumulator of the type with free electrolyte, like for example those intended for starting up thermal motors, substantially consists of a cover that closes a container provided on the inside with a plurality of dividing walls.

Such dividing walls define the cells inside which the plate groups of positive and negative polarity are arranged, completely immersed in the electrolyte, consisting of a diluted aqueous solution of sulphuric acid.

The plates, as known, are the seats where the charging and discharging reactions of the accumulator take place.

The cover is provided with a plurality of topping up holes, which can be closed by corresponding sealing caps, which allow the supply or the topping up of the electrolyte in each cell.

As known, the electrochemical processes that occur inside each cell during charging determine the separation by electrolysis of water with the consequent development of its constituent elements, hydrogen and oxygen.

These are disposed of through the single caps, which in such a case are provided with a suitable vent hole, or else through a discharge channel that, through as many inlet mouths, collects the gases developed in each cell and conveys them towards a single outlet mouth communicating with the-external environment.

The discharge channel is realised in the cover and the inlet mouths that collect the gases from the single cells are arranged above the free surface defined in each cell by the electrolyte.

To avoid accidental burning of the hydrogen coming out from the accumulator caused by external agents, such as sparks or naked flames, being able to penetrate inside the accumulator causing it to explode, the prior art foresees that an anti-explosion device be arranged close to the outlet mouth.

Such a device generally consists of a porous partition of ceramic or plastic material adapted to allow the passage of the gases emitted by the accumulator and at the same time to protect the accumulator against the risk of explosion.

A first drawback of lead accumulators with free electrolyte consists of the fact that they are exposed to the risk of losses of electrolyte. This may occur, for example, due to bad manoeuvring during transportation or due to an accident that has occurred to the means in which the accumulator is installed. It is clear that such a drawback can easily occur when the accumulator becomes arranged in a tilted or upside down position.

In such a situation, indeed, the electrolyte present in the cells reaches the inlet mouths of the discharge channel of the gases pushing up to the outlet mouth.

To at least partially overcome such drawbacks the prior art has proposed accumulators that inside the discharge duct have winding labyrinth paths that lengthen the discharge channel.

Such winding paths obstruct the progression of the electrolyte towards the outlet mouth and promote the condensation of the electrolyte mists carried by the gases emitted by the accumulator promoting its re-entry into each cell.

They are defined by vertical walls arranged in a suitable manner with respect to is each other inside the discharge channel.

A first drawback of the described solution consists of the fact that it does not allow the loss of electrolyte to be avoided but just allows its leakage to be delayed.

Such a drawback becomes ever more serious considering the tests and examinations that the accumulator must pass to respect the relative safety regulations and to be able to be desirable on the market.

Indeed, the tendency is to demand accumulators with free electrolyte that can operate or be recharged in the undesired positions described above for increasingly long time periods, without having losses of electrolyte.

In particular some tests foresee that the accumulator must remain upside down for a few minutes without having losses of electrolyte ensuring its correct operation both during and after the test.

Another drawback consists of the fact that the electrolyte that has leaked from a cell mixes inside the discharge channel with the electrolyte leaked from the other cells.

Another drawback linked to the previous one consists of the fact that the electrolyte present inside the discharge channel re-enters in random amounts inside each cell thus determining different levels of electrolyte in the various cells. This determines non-optimal working conditions for the accumulator that cause losses of efficiency of the accumulator itself and sometimes even its irreparable damage.

A further drawback consist of the fact that the vapours and the gases that do not condense are discharged to the outside contributing to lowering the level of electrolyte in the cells. This determines a worsening of the performance of the accumulator and a progressive damaging of the plates.

A further drawback consists of the fact that the level of electrolyte in each cell, which lowers for the aforementioned causes, must be periodically checked and hastily restored through onerous maintenance interventions.

Another drawback consists of the fact that such maintenance interventions must be carried out with a certain frequency.

The purpose of the present invention is to overcome said drawbacks.

In particular, a first purpose of the invention is to realise a cover for an electric accumulator with free electrolyte and a relative accumulator that does not have losses of electrolyte even if placed in critical positions.

Another purpose is to realise a cover and a relative accumulator that can operate to charge and discharge in the undesired positions described above even for considerable time periods, without having losses of electrolyte.

A further purpose is to realise a cover and an accumulator that have all of the necessary safety characteristics required by current standards and regulations.

Another purpose of the invention is to realise a cover and an accumulator that maintain their efficiency even after having taken up positions not suitable for its perfect operation without the need for corrective interventions.

A further purpose is to realise a cover and an accumulator that keep the level of electrolyte inside each cell substantially constant, even after having taken up positions different to those foreseen in normal operation.

Another purpose is to realise a cover and an accumulator that require less maintenance interventions per unit time with respect to comparable known accumulators.

The last but not least purpose is to realise an accumulator that is cost-effective and simple to realise.

Said purposes are accomplished by a cover for an electric accumulator of the type with free electrolyte adapted to be integral with the container of said accumulator, characterised in that it has at least one valve device having an inlet communicating with at least one cell of said accumulator and an outlet communicating with the external environment, said valve device being adapted to prevent the leaking of electrolyte present in said at least one cell and to allow the disposal to the outside of the gases that develop inside said accumulator when the pressure in said at least one cell exceeds a predetermined value.

In the same way, said purposes and advantages are accomplished by an electric accumulator of the type with free electrolyte that comprises:
a container provided on the inside with at least one cell adapted to house the plate groups of said accumulator and to contain the electrolyte;
at least one cover adapted to close said container;
   characterised in that said at least one cover is provided with the aforementioned solution.

Advantageously, the proposed solution allows the gases that develop inside the accumulator to be vented when they exceed a certain pressure and at the same time allows the leaking of the electrolyte to be avoided in the case of anomalous positioning of the accumulator.

Said purposes and advantages shall become clearer during the description of some preferred embodiments, given for indicating and not limiting purposes, with reference to the attached tables of drawings, where:

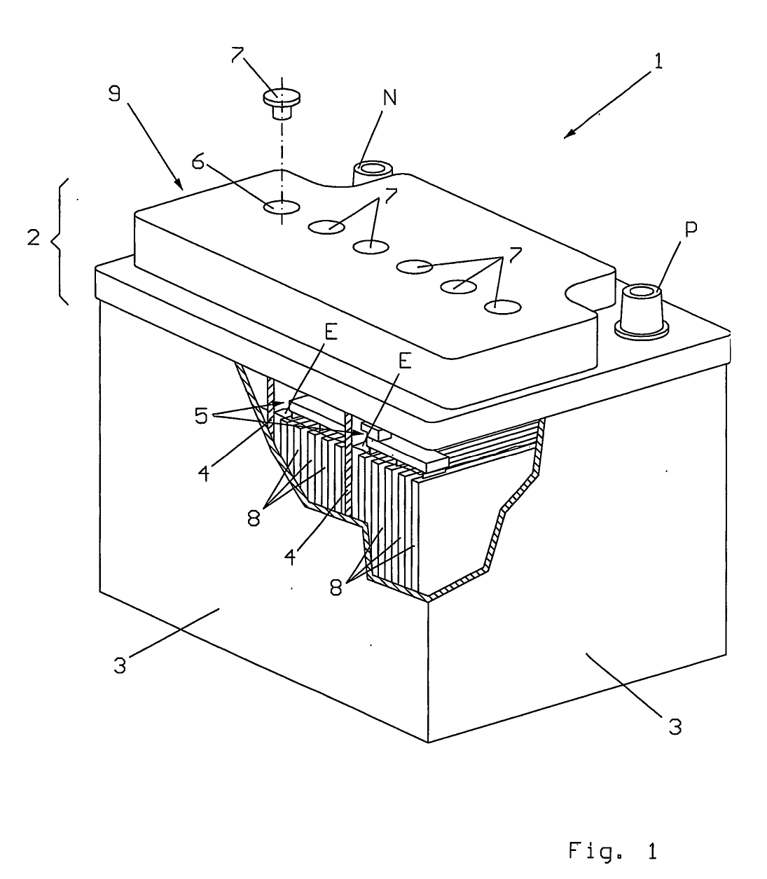

FIG. 1 represents a partially sectioned axonometric view of a cover for electric accumulators with free electrolyte object of the present invention, installed on an accumulator also object of the present invention;

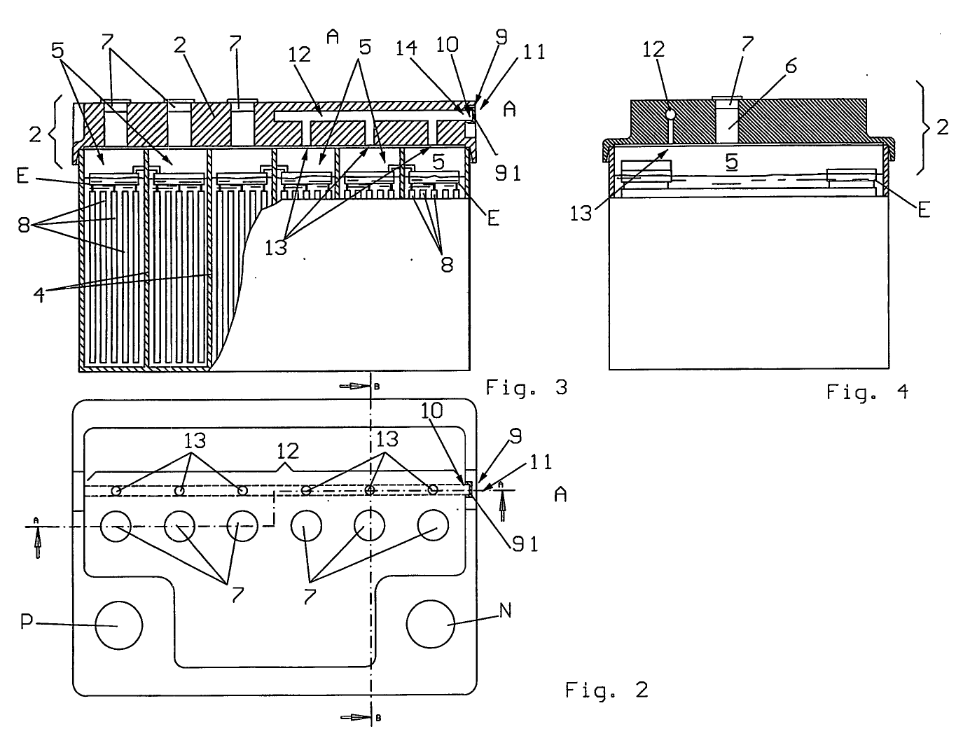

FIG. 2 represents a plan view of the cover and of the accumulator of FIG. 1;

FIG. 3 represents a side view of a partial section along the plane A-A of the cover and of the accumulator of FIG. 2;

FIG. 4 represents a side view of a partial section along the plane B-B of the cover and of the accumulator of FIG. 2;

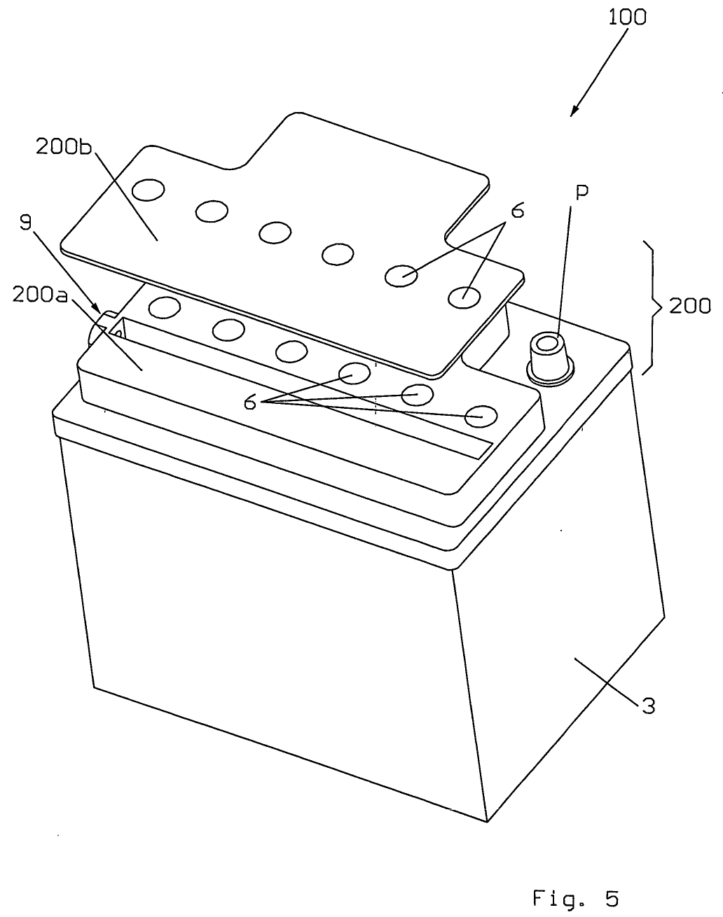

FIG. 5 represents an axonometric view of a variant embodiment of the cover and of the relative accumulator of FIG. 1;

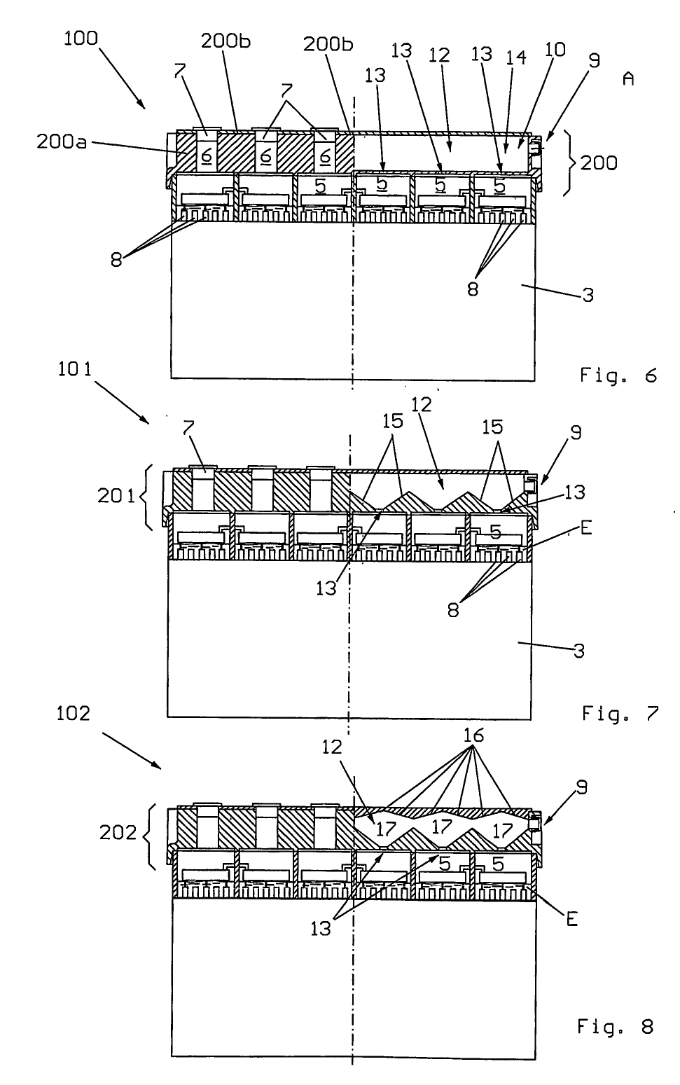

FIG. 6 represents a side view of a partial section of the cover and of the accumulator of FIG. 5 along a plane A-A analogous to that of FIG. 2;

FIG. 7 represents another side view of a partial section of a variant embodiment of the cover and of the accumulator of FIG. 5;

FIG. 8 represents another side view of a partial section of another variant embodiment of the cover and of the relative accumulator of FIG. 5;

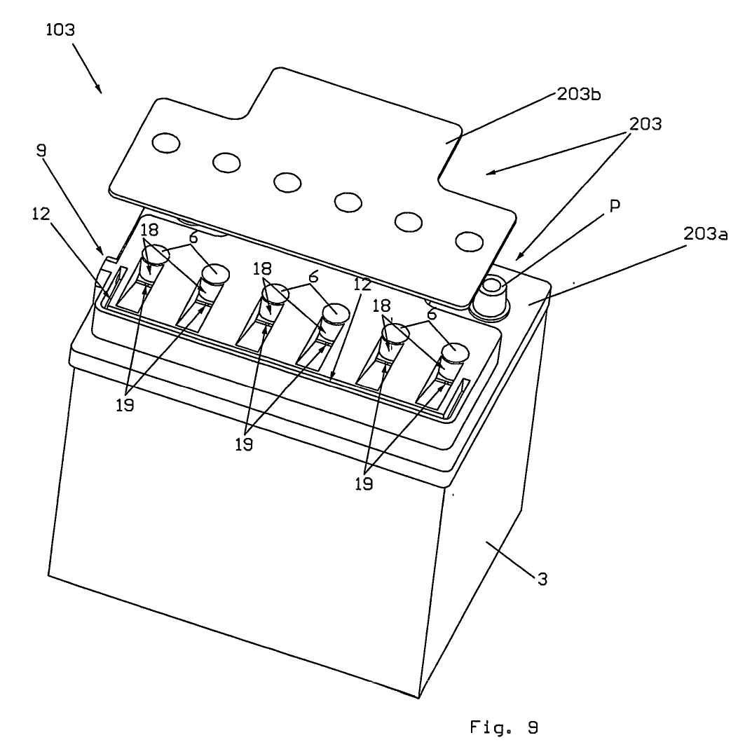

FIG. 9 represents an axonometric view of a variant embodiment of the cover and of the accumulator of FIG. 5;

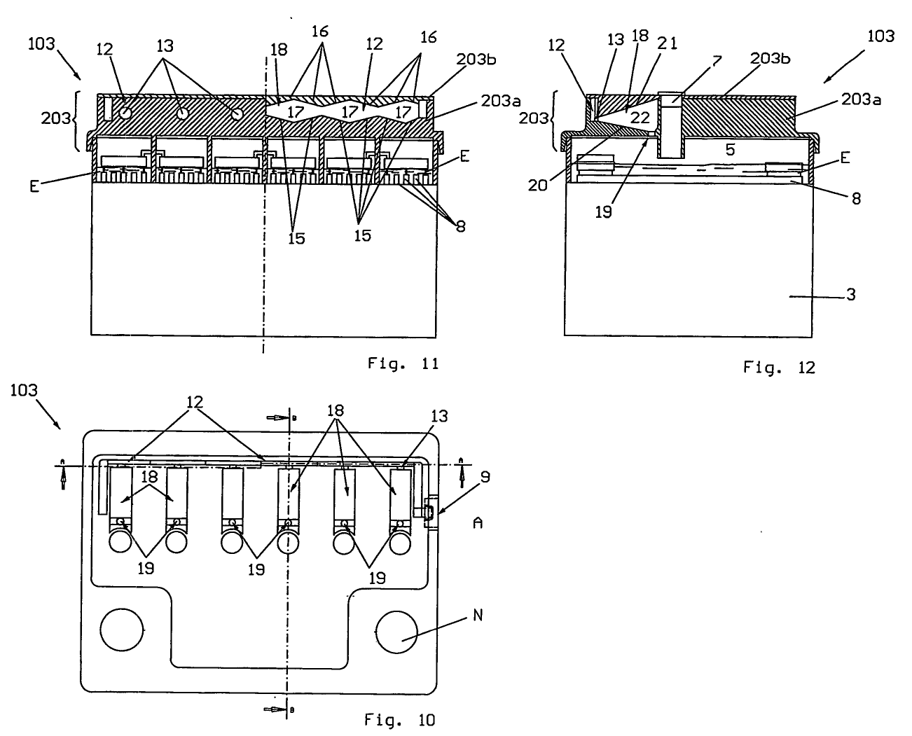

FIG. 10 represents a plan view of the cover and of the accumulator of FIG. 9;

FIG. 11 represents a side view of a partial section along the plane A-A of the cover and of the relative accumulator of FIG. 9;

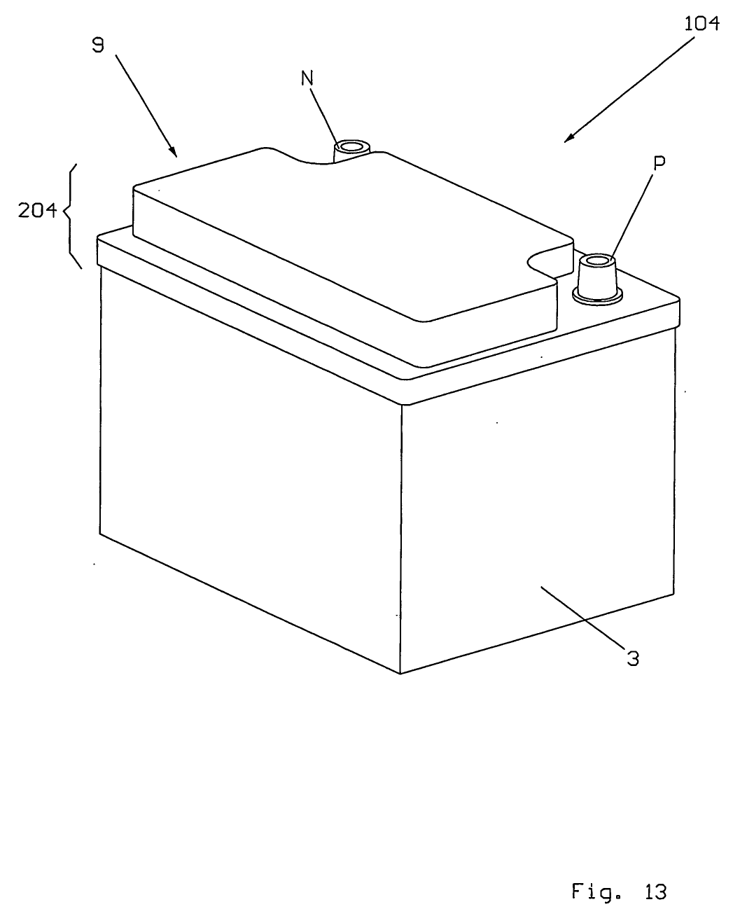

FIG. 12 represents a side view of a partial section along the plane B-B of the cover and of the accumulator of FIG. 9;

FIG. 13 represents an axonometric view of a variant embodiment of the cover and of the relative accumulator of FIG. 1;

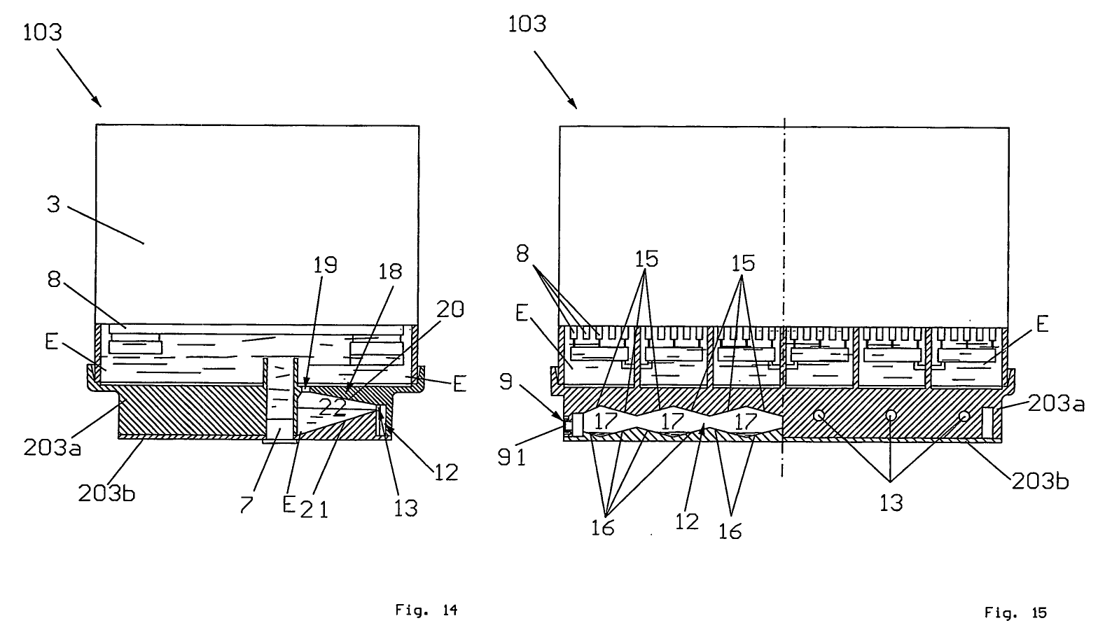

FIG. 14 represents a side view of a partial section along the plane B-B of the cover and of the accumulator of FIG. 9 upside down;

FIG. 15 represents a side view of a partial section along the plane A-A of the cover and of the accumulator of FIG. 9 upside down;

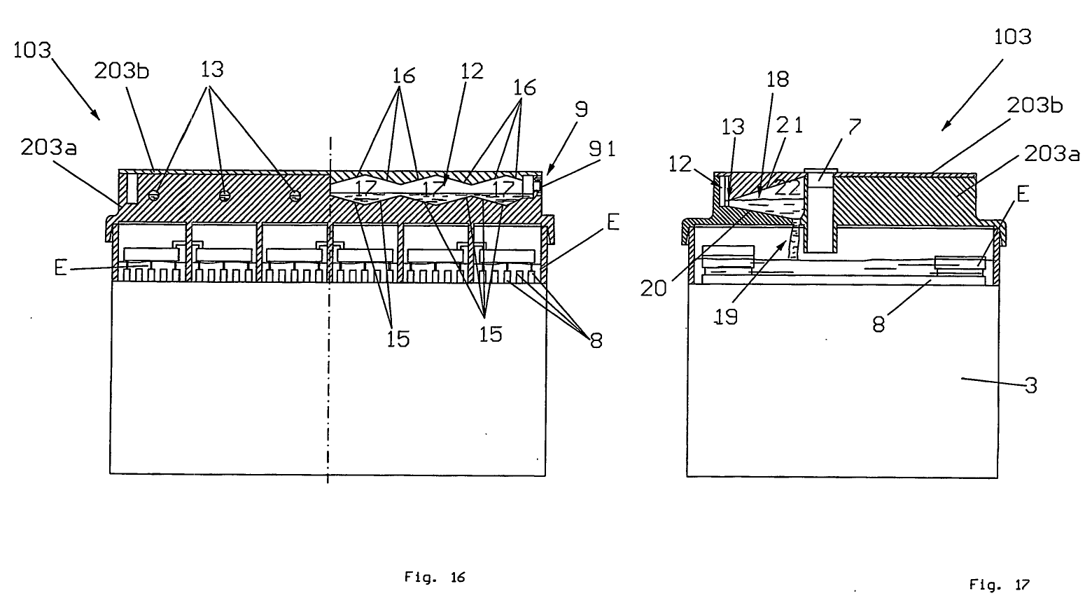

FIG. 16 represents a side view of a partial section along the plane A-A of the cover and of the accumulator of FIG. 9 in working position, after having been turned upside down;

FIG. 17 represents a side view of a partial section along the plane B-B of the cover and of the accumulator of FIG. 9 in working position, after having been turned upside down.

Although the described embodiments refer to particular lead accumulators with free acid, it is clear that the proposed solution can also be applied to other forms of accumulators with free electrolyte.

The cover for an electric accumulator of the type with free acid and the relative accumulator, object of the present invention are represented in FIG. 1, where they are wholly indicated with reference numerals 2 and 1, respectively.

The electric accumulator 1 substantially comprises the cover 2 that closes a container 3 at the top, provided on the inside with a plurality of vertical dividing walls 4 that define the cells 5 of the accumulator 1.

The cover 2 is provided with a plurality of inspection and topping up holes 6 of the cells 5, which can be closed through as many closing caps 7.

Each cell 5 is adapted to connect the electrolyte E and to house the groups of plates 8 electrically connected together so as to form the positive P and negative N polar terminals of the accumulator 1.

The invention foresees that the cover 2 comprises a valve device, wholly indicated with reference numeral 9, visible in detail in FIGS. 2 to 4, having an inlet 10 that communicates with the cells 5 and an outlet 11 communicating with the external environment A, to prevent the leaking of electrolyte E and to allow the disposal to the outside of the gases that develop inside the accumulator 1 when the pressure in one of the cells 5 exceeds a predetermined value.

In particular, the valve device 9 communicates with each cell 5 through a discharge channel 12.

Such a channel 12 has many inlet mouths 13, each communicating with one of the cells 5 and an outlet mouth 14, communicating with the inlet 10 of the valve device 9.

The valve device 9 prevents, as shall be seen more clearly hereafter, the leaking of electrolyte E both in normal operating conditions and in the critical conditions described above, whilst still keeping the pressure of the gases present inside each cell 5 under control.

The element 9 in the example consists of a unidirectional over-pressure valve 91 that intervenes when the internal pressure value of the accumulator 1 exceeds a predetermined value.

Such a predetermined value is greater or rather not less than the pressure exerted by the electrolyte head E on the inlet 10 of the element 9 when the accumulator 1 is arranged upside down.

This allows it to be ensured that even in such a position the electrolyte E does not leak from the accumulator 1.

In the described embodiment the element 9 comprises a tubular body closed by a base, removably coupled with a tubular collar realised in the cover close to an end of the discharge channel 12

As far as the discharge channel 12 is concerned, it is formed in the cover 2 of the accumulator 1 during the realisation of the cover itself.

A variant embodiment of the cover and of the accumulator wholly indicated with reference numeral 200 and 100 in FIGS. 5 and 6, differs from the previous one in that the cover 200 comprises a main body 200a and a closing element of the discharge channel 12 consisting of a foil 200b.

This allows the mould used to realise the cover 200 and its elements 200a and 200b to be simplified.

Another variant embodiment of the cover and of the accumulator wholly indicated with reference numeral 201 and 101 in FIG. 7 differs from the previous one in that the lower surface of the discharge channel 12 has many tilted planes 15, each converging towards one of the inlet mouths 13 to ease the re-entry of the electrolyte E into the cells 5.

A further variant embodiment of the cover and of the accumulator wholly indicated with 202 and 102 in FIG. 8, differs from the previous one in that the upper surface of the discharge channel 12 also has tilted planes 16, substantially mirroring the previous ones.

The interfacing tilted planes 15 and 16 in pairs define a series of first tanks 17 communicating with each other and suitable, as shall be better described hereafter, for further holding the electrolyte E that might leak from the respective cells 5 allowing its re-entry.

Another variant embodiment of the cover and of the accumulator wholly indicated with reference numeral 203 and 103 in FIGS. 9 to 12, differs from the previous one in that each inlet mouth 13 of the discharge channel 12 does not communicate directly with a respective cell 5.

More specifically, each inlet mouth 13 communicates with as many accumulation chambers 18, each in turn communicating with a respective cell 5 through a vent channel 19.

Each accumulation chamber 18 is formed on the main body 203a of the cover 203 and is closed at the top by the closing element 203b.

In the same way as the discharge channel 12, both the lower surface and the upper surface of the accumulation chamber 18 have tilted planes, respectively indicated with 20 and 21, substantially mirroring each other and converging towards the vent channel 19 to ease the re-entry of the electrolyte E into the corresponding cell 5.

The interfacing tilted planes 20 and 21 also define a series of first tanks 22, communicating with each other and suitable, as shall be seen more clearly hereafter, for further holding the electrolyte E to prevent it from mixing and to ease its return into the corresponding cell 5.

Another variant embodiment that has not been represented differs from the previous one in that each cell 5 is provided with its own valve device 9 arranged in the cover.

A further variant embodiment of the cover and of the accumulator wholly indicated with reference numeral 204 and 104 in FIG. 13, differs from the previous one in that the cover 204 does not have the topping up holes and the relative closing caps.

The description of the operation of the proposed accumulator shall now be made with reference to the variant embodiment represented in detail in FIGS. 9 to 14.

The assembly of the accumulator 103 foresees welding the plate groups 8 together with the corresponding separators and inserting them inside the respective cells 5.

Once the elements have been connected together and the main body 203a has been welded to the container, with heat sealing or equivalent procedures, the polar terminals P and N are welded.

Then one proceeds to the formation process of the plates with known methods filling each cell 5 with the formation electrolyte.

Having completed the formation process one proceeds to the application of the closing foil 203b with heat sealing or equivalent processes.

At the end of such operations the levels of electrolyte and of topping up liquid are those represented in FIGS. 11 and 12.

When inside the accumulator, due to its charging, the aforementioned gases is develop, these cause an increase in pressure inside a cell 5 that is detected by the valve device 9. As soon as such a pressure value exceeds the predefined threshold, the valve device 9 places the inside of the cells 5 in communication with the environment A, thus allowing the disposal or discharge of the gases.

In the case of the accumulator 103 turning upside down, the air present inside the discharge channel 12 and the accumulation chamber 18, not being able to be discharged in the external environment, thanks to the presence of the valve device 9, does not allow the electrolyte to leak from the cell 5.

Only if there is a pressure increase inside the accumulator 103 placed in such a position, as represented in detail in FIGS. 14 and 15, could the electrolyte leak from the cells 5.

In such a case the electrolyte E firstly pours back into the accumulation chambers 18 gradually filling up the corresponding tanks 22 and than reaches the discharge channel 12 through the inlet mouths 13 thus filling the second tanks 17.

Only once the tanks 17 have been filled does the electrolyte E coming from the various cells 5 mix.

The presence of the tilted planes 15 and 16 also ensures that, once the accumulator has been taken back into working position, the electrolyte E present in the channel 12, as represented in FIGS. 16 and 17, is conveyed in substantially equal amounts towards the accumulation chambers 18.

Finally, the planes 20 take the electrolyte E back into each cell 5.

From that which has been stated it is clear how the proposed solution allows a cover for accumulators with free electrolyte and relative accumulators to be realised that accomplish said purposes.

The proposed solution also allows the losses of electrolyte due to the carrying of s acid mists outside of the accumulator by the gases that develop in charging to be eliminated.

Indeed, the valve device 9, cooperating with the labyrinth realised in the discharge channel 12 and with the accumulation chambers 18, promotes the condensation of the gases and of the vapours that develop inside the cells.

It should also be noted that the proposed cover and accumulators can be realised in sizes conforming to the standards relative to accumulators for uses in starting or light traction.

It should be noted that both the discharge channel and the accumulation chambers can also be partially formed in the container 3.

Although the invention has been described with reference to the attached tables of drawings, it can undergo modifications in the embodiment step, all of which are covered by the same inventive concept expressed by the claims shown hereafter and therefore protected by the present patent.

1-12. (canceled)

13. Cover (2, 200, 201, 202, 203, 204) for an electric accumulator (1, 100, 101, 102, 103, 104) of the type with free electrolyte adapted to be integral with the container (3) of said accumulator (1, 100, 101, 102, 103, 104) said cover comprising at least one valve device (9) having an inlet (10) communicating with one or more cells (5) of said accumulator and an outlet communicating (11) with the external environment (A), said valve device being adapted to prevent the leaking of electrolyte (E) present in said one or more cells (5) and to allow the disposal to the outside of the gases that develop inside said accumulator (1, 100, 101, 102, 103, 104) when the pressure in said one or more cells (5) exceeds a predetermined value; said valve device (9) communicates with said one or more cells (5) through at least one discharge channel (12) having at least one inlet mouth (13) communicating with said one or more cells (5) and at least one outlet mouth (14) communicating with said inlet (10); characterised in that said at least one inlet mouth (13) communicates with said one or more cells (5) through at least one accumulation chamber (18) each communicating with one of said one or more cells (5) through at least one vent channel (19).

14. Cover (203) according to claim 13) characterised in that the lower surface of said accumulation chamber (18) has one or more tilted planes (20) converging towards said at least one vent channel (19) to ease the re-entry of the electrolyte (E) into the corresponding cell (5).

15. Cover (203) according to claim 13) characterised in that the upper surface of said accumulation chamber (18) has one or more upper tilted planes (21) that define second tanks (22) adapted to further hold said electrolyte (E).

16. Cover (201, 202, 203) according to claim 13) characterised in that the lower surface of said at least one discharge channel (12) has one or more tilted planes (15) converging towards said at least one inlet mouth (13) to ease the re-entry of the electrolyte (E) into said one or more cells (5) and to equally distribute the electrolyte (E) present in said at least one discharge channel (12) between said one or more cells (5).

17. Cover (202, 203) according to claim 13) characterised in that the upper surface of said discharge channel (12) has one or more tilted planes (16) that define first tanks (17) communicating with each other.

18. Cover (204) according to claim 13) characterised in that each of said one or more cells (5) is provided with at least one valve device (9).

19. Cover (2, 200, 201, 202, 203, 204) according to claim 13) characterised in that said at least one valve device (9) is an over-pressure valve.

20. Cover (2, 200, 201, 203, 204) according to claim 13) characterised in that said predetermined over-pressure value is not less than the pressure exerted by the head of said electrolyte (E) on said inlet (10) when said accumulator (1, 100, 101, 102, 103, 104) is arranged upside down.

21. Electric accumulator (1, 100, 101, 102, 103, 104) of the type with free electrolyte comprising:
a container (3) provided on the inside with at least one cell (5) adapted to house the plate groups (8) of said accumulator (1, 100, 101, 102, 103, 104) and to contain the electrolyte (E);
at least one cover (2, 200, 201, 203, 204) adapted to close said container (3);
characterised in that said at least one cover (2, 200, 201, 203, 204) is realised according to claim 13).

22. Electric accumulator (1, 100, 101, 102, 103, 104) of the type with free electrolyte comprising:
a container (3) provided on the inside with one or more cells (5) each adapted to house the plate groups (8) of said accumulator (1, 100, 101, 102, 103, 104) and to contain the electrolyte (E);
at least one cover (2, 200) adapted to close said container (3);
at least one valve device (9) having an inlet (10) communicating with at least one of said one or more cells (5) and an outlet communicating (11) with the external environment (A), to prevent the leaking of electrolyte (E) and to allow the disposal to the outside of the gases that develop inside said accumulator (1, 100, 101, 102, 103, 104) when the pressure in one of said one or more cells (5) exceeds a predetermined value;
wherein said valve device (9) communicates with said one or more cells (5) through at least one discharge channel (12) having at least one inlet mouth (13) communicating with at least one of said one or more cells (13) and at least one outlet mouth (14) communicating with said inlet (10);
characterized in that said at least one inlet mouth (13) communicates with said one or more cells (5) through at least one accumulation chamber (18) each communicating with one of said one or more cells (5) through at least one vent channel (19).

23. Accumulator (103) according to claim 22) characterised in that the lower surface of said accumulation chamber (18) has one or more tilted planes (20) converging towards said at least one vent channel (19) to ease the re-entry of the electrolyte (E) into the corresponding cell (5).

24. Accumulator (103) according to claim 22) characterised in that the upper surface of said accumulation chamber (18) has one or more upper tilted planes (21) that define second tanks (22) adapted to further hold said electrolyte (E).

25. Accumulator (101, 102, 103) according to claim 22) characterised in that the lower surface of said at least one discharge channel (12) has one or more tilted planes (15) converging towards said at least one inlet mouth (13) to ease the re-entry of the electrolyte (E) into said one or more cells (5) and to equally distribute the electrolyte (E) present in said at least one discharge channel (12) between said one or more cells (5).

26. Accumulator (102, 103) according to claim 22) characterised in that the upper surface of said discharge channel (12) has one or more tilted planes (16) that define first tanks (17) communicating with each other.

27. Accumulator (1, 100, 101, 102, 103) according to claim 22) characterised in that at least one portion of said at least one discharge channel (12) is realised in the cover (2, 200) of said accumulator (1, 100, 101, 102, 103).

28. Accumulator (103) according to claim 22) characterised in that at least one part of said accumulation chambers (18) is realised in the cover of said accumulator (103).

29. Accumulator (1, 100, 101, 102, 103) according to claim 22) characterised in that at least one portion of said at least one discharge channel (12) is realised in the container (3) of said accumulator (1, 100, 101, 102, 103).

30. Accumulator (103) according to claim 22) characterised in that at least one part of said accumulation chambers (18) is realised in the container (3) of said accumulator (103).

31. Accumulator (104) according to claim 22) characterised in that each of said one or more cells (5) is provided with at least one valve device (9).

32. Accumulator (1, 100, 101, 102, 103, 104) according to claim 22) characterised in that said at least one value device (9) is an over-pressure valve.

33. Accumulator (1, 100, 101, 102, 103, 104) according to claim 22) characterised in that said predetermined over-pressure value is not less man the pressure exerted by me head of said electrolyte (E) on said inlet (10) when said accumulator (1, 100, 101, 102, 103, 104) is arranged upside down.
